(19) United States
(12) Patent Application Publication
(10) Pub. No.: US 2019/0303364 A1
(43) Pub. Date: Oct. 3, 2019

(54) SEARCHING METHOD AND APPARATUS, DEVICE AND NON-VOLATILE COMPUTER STORAGE MEDIUM

(71) Applicant: BAIDU ONLINE NETWORK TECHNOLOGY (BEIJING) CO., LTD., Beijing (CN)

(72) Inventors: Bolei HE, Beijing (CN); Weimeng ZHANG, Beijing (CN); Xingjian LI, Beijing (CN); Yanjun MA, Beijing (CN)

(73) Assignee: BAIDU ONLINE NETWORK TECHNOLOGY (BEIJING) CO., LTD., Beijing (CN)

(21) Appl. No.: 16/304,624

(22) PCT Filed: Aug. 25, 2016
(86) PCT No.: PCT/CN2016/096653

§ 371 Date: Nov. 26, 2018

(30) Foreign Application Priority Data
May 24, 2016 (CN) 201610348789.9

(51) Int. Cl. G06F 16/248; G06F 16/28

(52) U.S. Cl. CPC G06F 16/248; G06F 16/287

(57) ABSTRACT

The present disclosure provides a searching method and apparatus, a device and a non-volatile computer memory medium. According to embodiments of the present disclosure, it is possible to output the clustered search result under the potential demand by obtaining a search result according to the obtained query keyword, and then clustering the search result under the potential demand of the query keyword. Since the user might have demands in one or more aspects, clustering the search result corresponding to the query keyword under one or more potential demands of the query keyword can enable the user to easily obtain content in a class under a certain potential demand, and can effectively satisfy the user's relevant demands appearing during the search.

The present disclosure claims priority to the Chinese patent application No. 201610348789.9 entitled “Searching Method and Apparatus” filed on the filing date May 24, 2016, the entire disclosure of which is hereby incorporated by reference in its entirety.

### FIELD OF THE DISCLOSURE

The present disclosure relates to Internet technologies, and particularly to a searching method and apparatus, a device and a non-volatile computer memory medium.

### BACKGROUND OF THE DISCLOSURE

A search engine refers to a system which collects information from the Internet according to certain policies and by using a specific computer program, provides users with search service after organizing and processing the information, and displays search-related information to the user. According to reports of State Statistics Bureau, the number of China's netizens already exceeds 400 millions. The data means that China already becomes the world's largest netizen country surpassing the United States, and furthermore, a total number of China's websites already exceeds 2 millions. Hence, how to provide the searching service to meet users' demands to a maximum degree is always an important subject for Internet enterprises. When a user searches by using a simple query keyword, he might have demands in one or more aspects. For example, if the query keyword is diabetes, his demand might be some content related to diet with respect to diabetes, not other content including diabetes.

Therefore, it is desirable to provide a searching method which meets users' relevant demands appearing during the search.

### SUMMARY OF THE DISCLOSURE

A plurality of aspects of the present disclosure provide a searching method and apparatus, a device and a non-volatile computer memory medium, to satisfy the user's relevant demands appearing during the search.

According to an aspect of the present disclosure, there is provided a searching method, comprising:

obtaining a query keyword;

obtaining a search result according to the query keyword;

clustering the search result under a potential demand of the query keyword;

outputting the clustered search result under the potential demand.

The above aspect and any possible implementation mode further provide an implementation mode: before clustering the search result under a potential demand of the query keyword, the method further comprises:

obtaining the potential demand of the query keyword.

The above aspect and any possible implementation mode further provide an implementation mode: the obtaining the potential demand of the query keyword comprises:

obtaining the potential demand of the query keyword according to the query keyword and a correspondence relationship between the designated query keyword and potential demand.

The above aspect and any possible implementation mode further provide an implementation mode: before obtaining the potential demand of the query keyword according to the query keyword and a correspondence relationship between the designated query keyword and potential demand, the method further comprises:

obtaining user's historical behavior data related to the designated query keyword:

obtaining historical demands of the designated query keyword according to the user's historical behavior data;

according to the historical demands, obtaining the potential demand corresponding to the designated query keyword; and

establishing the correspondence relationship between the designated query keyword and the potential demand.

The above aspect and any possible implementation mode further provide an implementation mode: the obtaining the potential demand of the query keyword comprises:

according to the search result, obtaining a potential demand to which the search result belongs, as the potential demand of the query keyword.

The above aspect and any possible implementation mode further provide an implementation mode: the step of, according to the search result, obtaining a potential demand to which the search result belongs, as the potential demand of the query keyword comprises:

obtaining a search demand to which the search result belongs, according to the search result; and

obtaining the potential demand of the query keyword according to the search demand.

The above aspect and any possible implementation mode further provide an implementation mode: the outputting the clustered search result under the potential demand comprises:

outputting the clustered search results under the potential demand, in a designated area in a search result page.

According to another aspect of the present disclosure, there is provided a searching apparatus, comprising:

an obtaining unit configured to obtain a query keyword;

a processing unit configured to obtain a search result according to the query keyword;

a clustering unit configured to cluster the search result under a potential demand of the query keyword;

an outputting unit configured to output the clustered search result under the potential demand.

The above aspect and any possible implementation mode further provide an implementation mode: the clustering unit is further configured to

obtain the potential demand of the query keyword.

The above aspect and any possible implementation mode further provide an implementation mode: the clustering unit is specifically configured to

obtain the potential demand of the query keyword according to the query keyword and a correspondence relationship between the designated query keyword and potential demand.

The above aspect and any possible implementation mode further provide an implementation mode: the clustering unit is further configured to

obtain user's historical behavior data related to the designated query keyword;

obtain historical demands of the designated query keyword according to the user's historical behavior data;

according to the historical demands, obtain the potential demand corresponding to the designated query keyword; and

establish the correspondence relationship between the designated query keyword and the potential demand.

The above aspect and any possible implementation mode further provide an implementation mode: the clustering unit is specifically configured to

according to the search result, obtain a potential demand to which the search result belongs, as the potential demand of the query keyword.

The above aspect and any possible implementation mode further provide an implementation mode: the clustering unit is specifically configured to

obtain a search demand to which the search result belongs, according to the search result; and

obtain the potential demand of the query keyword according to the search demand.

The above aspect and any possible implementation mode further provide an implementation mode: the outputting unit is specifically configured to

output the clustered search results under the potential demand, in a designated area in a search result page.

According to a further aspect of the present disclosure, there is provided a device, comprising

one or more processors;

a memory;

one or more programs stored in the memory and configured to execute the following operations when executed by the one or more processors:

obtain a query keyword;

obtain a search result according to the query keyword;

cluster the search result under a potential demand of the query keyword;

output the clustered search result under the potential demand.

According to a further aspect of the present disclosure, there is provided a non-volatile computer storage medium in which one or more programs are stored, an apparatus being enabled to execute the following operations when said one or more programs are executed by the apparatus:

obtain a query keyword;

obtain a search result according to the query keyword;

cluster the search result under a potential demand of the query keyword;

output the clustered search result under the potential demand.

As known from the technical solutions, according to embodiments of the present disclosure, it is possible to output the clustered search result under the potential demand by obtaining a search result according to the obtained query keyword, and then clustering the search result under the potential demand of the query keyword. Since the user might have demands in one or more aspects, clustering the search result corresponding to the query keyword under one or more potential demands of the query keyword can enable the user to easily obtain content in a class under a certain potential demand, and can effectively satisfy the user's relevant demands appearing during the search.

In addition, the technical solutions according to the present disclosure can be employed to effectively improve the user's experience.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts.

FIG. 1 is a flow chart of a searching method according to an embodiment of the present disclosure;

FIG. 2 is a structural schematic diagram of a searching apparatus according to another embodiment of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

It needs to be appreciated that the terminal involved in the embodiments of the present disclosure comprises but is not limited to a mobile phone, a Personal Digital Assistant (PDA), a wireless handheld device, a tablet computer, a personal computer (PC), a MP3 player, a MP4 player and a wearable device (e.g., smart glasses, a smart watch and a smart bracelet).

It should be appreciated that the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship.

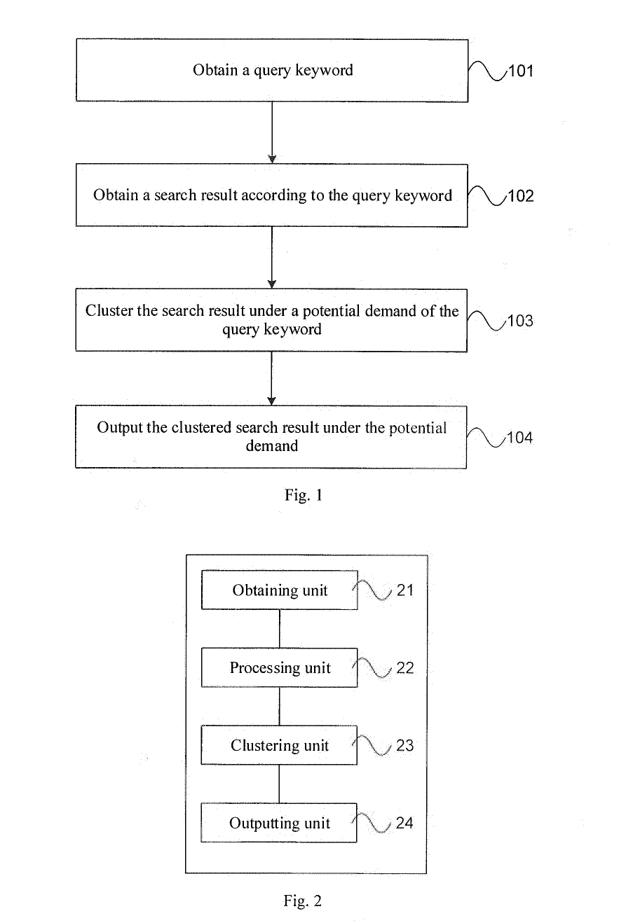

FIG. 1 is a flow chart of a searching method according to an embodiment of the present disclosure. As shown in FIG. 1, the method comprises the following steps:
101: obtaining a query keyword.
102: obtaining a search result according to the query keyword.
103: clustering the search result under a potential demand of the query keyword.
104: outputting the clustered search result under the potential demand.

It needs to be appreciated that part or all of subjects for implementing 101-104 may be an application located in a local terminal, or may further be a function unit such as a plug-in or Software Development Kit (SDK) located in the application of the local terminal, or may be a search engine located in a network-side server, or may be a distributed system located on the network side. This is not particularly limited in the present embodiment.

It may be understood that the application may be a native application (nativeAPP) installed on the terminal, or a web application (webAPP) of a browser on the terminal. This is not specifically limited in the present embodiment.

As such, it is possible to output the clustered search result under the potential demand by obtaining a search result according to the obtained query keyword, and then clustering the search result under the potential demand of the query keyword. Since the user might have demands in one or more aspects, clustering the search result corresponding to the query keyword under one or more potential demands of the query keyword can enable the user to easily obtain content in a class under a certain potential demand, and can effectively satisfy the user's relevant demands appearing during the search.

Optionally, in a possible implementation mode of the present embodiment, at 101, it is specifically possible to collect the query keyword provided by the user. Specifically, this may be implemented through a search command triggered by the user. The search command may be specifically triggered in the following manners, but not limited to the following manners:

Manner 1:

The user may input the query keyword on a page displayed by a current application, and then click a search button for example Baidu on the page to trigger the search command which includes the query keyword. The user may input the query keyword in any order. As such, after the search command is received, it is possible to parse to obtain the query keyword included therein.

Manner 2:

It is possible to employ an asynchronous uploading technology such as Ajax asynchronous uploading or Jsonp asynchronous uploading, to obtain, in real time, the content input by the user on the page displayed by the current application. To differentiate from the query keyword, the content input this time may be called an input query keyword. The user may input the query keyword in any order. Specifically, an interface such as an Ajax interface or Jsonp interface may be provided. These interfaces may be programmed in a language such as Java or Hypertext Preprocessor (PHP) language, its specific invocation being performed with Jquery keyword, or programmed in a native language such as JavaScript.

Manner 3: The user may long press a speech search button on a page displayed by the current application, speak out speech content to be input, and then release the speech search button to trigger the search command, the search command including the query keyword in a text form converted from the spoken speech content. As such, after the search command is received, it is possible to parse to obtain the query keyword included therein.

Manner 4: The user may click a speech search button on a page displayed by the current application, speak out speech content to be input, and then trigger the search command after a period of time, e.g., 2 seconds after completion of the speaking of the speech content, the search command including the query keyword in a text form converted from the spoken speech content. As such, after the search command is received, it is possible to parse to obtain the query keyword included therein.

After the input query keyword is obtained, subsequent operations, namely, 102-104 may be executed.

Optionally, in a possible implementation mode of the present embodiment, at 102, it is specifically possible to employ a conventional searching method to obtain a search result corresponding to the query keyword. For particulars, please refer to relevant content in the prior art, and details are not provided here any more.

Optionally, in a possible implementation mode of the present embodiment, before 103, it is further possible to obtain the potential demand of the query keyword.

In a specific implementation process, first, it is specifically possible to obtain the potential demand of the query keyword according to the query keyword and a correspondence relationship between the designated query keyword and potential demand. First, the query keyword is used to match with the query keyword. If the matching is successful, it is possible to query keyword, in the correspondence relationship between the designated query keyword and the potential demand, for the potential demand corresponding to the matched designated query keyword, as the potential demand of the query keyword.

Specifically, before the implementation process, it is further necessary to pre-establish the correspondence relationship between the designated query keyword and potential demand. In this method, offline mining can satisfy mining of demands of hot queries.

Specifically, it is specifically possible to obtain user's historical behavior data related to the designated query keyword, and then obtain historical demands of the designated query keyword according to the user's historical behavior data. Then, it is possible to, according to the historical demands, obtain the potential demand corresponding to the designated query keyword, and establish the correspondence relationship between the designated query keyword and the potential demand.

Here, the user's historical behavior data related to the designated query keyword may be collected depending on the user's user intention session data. The session is a logic s and it represents the user's one behavior intention within a certain period of time. From perspective of the user's browsing behaviors, the session may be specifically specified as a continuous search behavior which has the same association grammatically.

First, it is first necessary to mine changes of the user's demands from the session data, and secondly obtain changes of the query keyword according to click information of a Uniform Resource Locator (URL). As such, it is possible to obtain the designated query keyword generated by most demand changes under a query keyword.

Then, it is possible to obtain historical demands of the designated query keyword by two methods.

One method is a Lexical Answer Type (LAT) method, for example, a LAT corresponding to the designated query keyword “a treatment method of diabetes” is “treatment method”, namely, historical demand of the designated query keyword.

The other method is a part of speech collocation method, for example, a part of speech template collocation such as the designated query keyword “noun+stop word+noun”. It is possible to regard a suffix noun as a demand word, namely, the historical demand of the designated query keyword.

After the historical demands of the designated query keyword are obtained, it is possible to perform aggregation processing for the historical demands corresponding to the designated query keyword to obtain an aggregated historical demand, for example, it is possible to perform aggregation processing for “treatment method” and “treatment solution” to obtain an aggregation result “treatment method”. Specifically, the aggregation processing may be specifically performed by three methods.

The first method is a synonym judgment method: judging according to a synonym list whether two historical demands are expression methods of the same demand;

The second method is a relevancy calculation method. It is possible to judge whether two demand words are expression manners under the same demand by calculating a literal relevancy degree of the two demand words;

The third method is a statistics-based method depending on annotation data. A specific requirement of this method is first annotating a batch of duly aggregated data, and then performing clustering by a model clustering method.

After the aggregated historical demands are obtained, it is possible to perform normalization processing for these aggregated historical demands to obtain normalized aggregated demands, and regard unaggregated historical demands and normalized aggregated demands as potential demands corresponding to the designated query keyword.

As such, the historical demands of the designated query keyword are obtained. It is possible to, based on the obtained historical demands of the designated query keyword, further establish a correspondence relationship between the designated query keyword and the potential demands. Specifically, the correspondence relationship may be specifically stored in a storage device of the terminal.

For example, the storage device of the terminal may be a slow-speed storage device, and may specifically be a hard disk of a computer system, or may be a non-running memory of a mobile phone, namely, a physical memory, for example, a Read-Only Memory (ROM) and a memory card. This is not particularly limited in the present embodiment.

Or, for another example, the storage device of the terminal may further be a fast-speed storage device, and may specifically be a memory of a computer system, or may further be a running memory of a mobile phone, namely, a system memory, for example, a Random Access Memory (RAM). This is not particularly limited in the present embodiment.

In another specific implementation procedure, it is specifically possible to, according to the search result, obtain a potential demand to which the search result belongs, as the potential demand of the query keyword. In this method, online mining can solve mining of the demands of unpopular queries.

Specifically, it is specifically possible to obtain a search demand to which the search result belongs, according to the search result, and then obtain the potential demand of the query keyword according to the search demand.

It is possible to obtain the search demand to which a search result belongs, in two methods.

One method is a Lexical Answer Type (LAT) method.

Specifically, it is possible to first perform LAT analysis for a title of a page corresponding to the search result, and then perform question type analysis for the title of the page. A search demand of the search result is comprehensively calculated from results of analysis of the above two times. The so-called page sometimes may be called a World Wide Web page, or may be a webpage written in a Hypertext Markup Language (HTML), namely, an HTML page, or may be a webpage written in languages HTML and Java, namely, a Java Server Page (JSP), or may further be a webpage written in other programming languages. This is not particularly limited in the present embodiment.

Specifically, the page may include a display block, called a page element such as text, graph, hyperlink, button, edit box, or dropdown box, defined by one or more page labels, for example, Hypertext Markup Language (HTML) label and JSP label. This is not particularly limited in the present embodiment.

After the search demand of the search result is obtained, it is possible to perform aggregation processing for the search demand corresponding to the search result to obtain an aggregated search demand, for example, it is possible to perform aggregation processing for “treatment method” and “treatment solution” to obtain an aggregation result “treatment method”. Specifically, the aggregation processing may be specifically performed by three methods.

The first method is a synonym judgment method: judging according to a synonym list whether two search demands are expression methods of the same demand;

The second method is a relevancy calculation method. It is possible to judge whether two demand words are expression manners under the same demand by calculating a literal relevancy degree of the two demand words;

The third method is a statistics-based method depending on annotation data. A specific requirement of this method is first annotating a batch of duly aggregated data, and then performing clustering by a model clustering method.

After the aggregated search demands are obtained, it is possible to perform normalization processing for these aggregated search demands to obtain normalized aggregated demands, and regard unaggregated search demands and normalized aggregated demands as potential demands of the query keyword.

Another method is a non-LAT method. Regarding this method, it is possible to obtain a search result in the case that a result is empty. The method is advantageous in abstractly characterizing the user's demand from the content end, reducing the user's own induction process, and helping the user to improve the searching efficiency.

Specifically, the search demand of the search result in this case may be obtained by two methods.

Method 1 is a serial number label method. It is feasible to first extract serial number labels in a page corresponding to the search result, and then calculate a relevancy between content (e.g., short sentence) after these serial number labels and the title of the page. If the relevancy is larger than or equal to a preset threshold, this indicates that the content is a subtitle of the page, and then the content may be regarded as a search demand of the search result.

Method 2 is a subject segmentation method. When a single page does not include subtitle information, it is necessary to depend on the subject segmentation technology. Its purpose lies in summarizing paragraphs in the page, and then perform subject extraction, and then regarding the subject extracted from each paragraph as a search demand of the search result.

After the search demand of the search result is obtained, it is possible to perform aggregation processing for the search demand corresponding to the search result to obtain an aggregated search demand, for example, it is possible to perform aggregation processing for “treatment method” and “treatment solution” to obtain an aggregation result “treatment method”. Specifically, the aggregation processing may be specifically performed by three methods.

The first method is a synonym judgment method: judging according to a synonym list whether two search demands are expression methods of the same demand;

The second method is a relevancy calculation method. It is possible to judge whether two demand words are expression manners under the same demand by calculating a literal relevancy degree of the two demand words;

The third method is a statistics-based method depending on annotation data. A specific requirement of this method is first annotating a batch of duly aggregated data, and then performing clustering by a model clustering method.

After the aggregated search demands are obtained, it is possible to perform normalization processing for these aggregated search demands to obtain normalized aggregated demands, and regard unaggregated search demands and normalized aggregated demands as potential demands of the query keyword.

Optionally, in a possible implementation mode of the present embodiment, in 104, it is specifically feasible to output the clustered search results under the potential demand, in a designated area in the search result page. For example, it is possible to respectively output, in the topmost part of the search result page, the clustered search results under two potential demands corresponding to the query keyword. Other areas in the search result page other than the designated area may output other search results in turn according to current rules.

Furthermore, to make the search results have clearer readability, it is further possible to, upon outputting the clustered search results under the potential demand, further output indication information to indicate the potential demand.

In the present embodiment, it is possible to output the clustered search results under the potential demand by obtaining a search result according to the obtained query keyword, and then clustering the search result under the potential demand of the query keyword. Since the user might have demands in one or more aspects, clustering the search result corresponding to the query keyword under one or more potential demands of the query keyword can enable the user to easily obtain content in a class under a certain potential demand, and can effectively satisfy the user's relevant demands appearing during the search.

In addition, the technical solutions according to the present disclosure can be employed to effectively improve the user's experience.

It needs to be appreciated that regarding the aforesaid method embodiments, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

FIG. 2 is a structural schematic diagram of a searching apparatus according to another embodiment of the present disclosure. As shown in FIG. 2, the searching apparatus according to the present embodiment may comprise an obtaining unit 21, a processing unit 22, a clustering unit 23 and an outputting unit 24, wherein the obtaining unit 21 is configured to obtain a query keyword; the processing unit 22 is configured to obtain a search result according to the query keyword; the clustering unit 23 is configured to cluster the search result under a potential demand of the query keyword; the outputting unit 24 is configured to output the clustered search result under the potential demand.

It needs to be appreciated that part or all of the searching apparatus according to the present embodiment may be an application located in a local terminal, or may further be a function unit such as a plug-in or Software Development Kit (SDK) located in the application of the local terminal, or may be a search engine located in a network-side server, or may be a distributed system located on the network side. This is not particularly limited in the present embodiment.

It may be understood that the application may be a native application (nativeAPP) installed on the terminal, or a web application (webAPP) of a browser on the terminal. This is not specifically limited in the present embodiment.

Optionally, in a possible implementation mode of the present embodiment, the clustering unit 23 is further configured to obtain the potential demand of the query keyword.

In a specific implementation procedure, the clustering unit 23 may specifically be configured to obtain the potential demand of the query keyword according to the query keyword and a correspondence relationship between the designated query keyword and potential demand.

Specifically, the clustering unit 23 may be further configured to obtain user's historical behavior data related to the designated query keyword; obtain historical demands of the designated query keyword according to the user's historical behavior data; according to the historical demands, obtain the potential demand corresponding to the designated query keyword; and establish the correspondence relationship between the designated query keyword and the potential demand.

In another specific implementation procedure, the clustering unit 23 may be specifically configured to, according to the search result, obtain a potential demand to which the search result belongs, as the potential demand of the query keyword.

Specifically, the clustering unit 23 may be specifically configured to obtain a search demand to which the search result belongs, according to the search result; and obtain the potential demand of the query keyword according to the search demand.

Optionally, in a possible implementation mode of the present embodiment, the outputting unit 24 may specifically configured to output the clustered search results under the potential demand, in a designated area in the search result page.

It needs to be appreciated that the method in the embodiment corresponding to FIG. 1 may be implemented by the searching apparatus according to the present embodiment. Reference may be made to relevant content in the embodiment corresponding to FIG. 1 for detailed description, which will not be detailed any longer here.

In the present embodiment, the processing unit obtains a search result according to the query keyword obtained by the obtaining unit, and then the clustering unit clusters the search result under the potential demand of the query keyword, so that the outputting unit outputs the clustered search results under the potential demand. Since the user might have demands in one or more aspects, clustering the search results corresponding to the query keyword under one or more potential demands of the query keyword can enable the user to easily obtain content in a class under a certain potential demand, and can effectively satisfy the user's relevant demands appearing during the search.

In addition, the technical solutions according to the present disclosure can be employed to effectively improve the user's experience.

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed system, apparatus and method can be implemented through other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not make essence of corresponding technical solutions depart from the spirit and scope of technical solutions of embodiments of the present disclosure.

What is claimed is:

1. A searching method, wherein the method comprises:
obtaining a query keyword;
obtaining a search result according to the query keyword;
clustering the search result under a potential demand of the query keyword;
outputting the clustered search result under the potential demand.

2. The method according to claim 1, wherein before clustering the search result under a potential demand of the query keyword, the method further comprises:
obtaining the potential demand of the query keyword.

3. The method according to claim 2, wherein the obtaining the potential demand of the query keyword comprises:
obtaining the potential demand of the query keyword according to the query keyword and a correspondence relationship between the designated query keyword and potential demand.

4. The method according to claim 3, wherein before obtaining the potential demand of the query keyword according to the query keyword and a correspondence relationship between the designated query keyword and potential demand, the method further comprises:
obtaining user's historical behavior data related to the designated query keyword;
obtaining historical demands of the designated query keyword according to the user's historical behavior data;
according to the historical demands, obtaining the potential demand corresponding to the designated query keyword; and
establishing the correspondence relationship between the designated query keyword and the potential demand.

5. The method according to claim 2, wherein the obtaining the potential demand of the query keyword comprises:
according to the search result, obtaining a potential demand to which the search result belongs, as the potential demand of the query keyword.

6. The method according to claim 5, wherein the step of, according to the search result, obtaining a potential demand to which the search result belongs, as the potential demand of the query keyword comprises:
obtaining a search demand to which the search result belongs, according to the search result; and
obtaining the potential demand of the query keyword according to the search demand.

7. The method according to claim 1, wherein the outputting the clustered search result under the potential demand comprises:
outputting the clustered search results under the potential demand, in a designated area in a search result page.

8-14. (canceled)

15. A device, comprising
one or more processors;
a memory;
one or more programs stored in the memory and configured to implement a searching method when executed by the one or more processors, wherein the method comprises:
obtaining a query keyword;
obtaining a search result according to the query keyboard;
clustering the search result under a potential demand of the query keyword;
outputting the clustered search result under the potential demand.

16. A non-volatile computer storage medium in which one or more programs are stored, an apparatus being enabled to implement a searching method when said one or more programs are executed by the apparatus, wherein the method comprises:
obtaining a query keyword;
obtaining a search result according to the query keyboard;
clustering the search result under a potential demand of the query keyword;
outputting the clustered search result under the potential demand.

17. The device according to claim 15, wherein before clustering the search result under a potential demand of the query keyword, the method further comprises:
obtaining the potential demand of the query keyword.

18. The device according to claim 17, wherein the obtaining the potential demand of the query keyword comprises:
obtaining the potential demand of the query keyword according to the query keyword and a correspondence relationship between the designated query keyword and potential demand.

19. The device according to claim 18, wherein before obtaining the potential demand of the query keyword according to the query keyword and a correspondence relationship between the designated query keyword and potential demand, the method further comprises:
obtaining user's historical behavior data related to the designated query keyword;
obtaining historical demands of the designated query keyword according to the user's historical behavior data;
according to the historical demands, obtaining the potential demand corresponding to the designated query keyword; and
establishing the correspondence relationship between the designated query keyword and the potential demand.

20. The device according to claim 17, wherein the obtaining the potential demand of the query keyword comprises:
according to the search result, obtaining a potential demand to which the search result belongs, as the potential demand of the query keyword.

21. The device according to claim 20, wherein the step of, according to the search result, obtaining a potential demand to which the search result belongs, as the potential demand of the query keyword comprises:
obtaining a search demand to which the search result belongs, according to the search result; and
obtaining the potential demand of the query keyword according to the search demand.

22. The device according to claim 15, wherein the outputting the clustered search result under the potential demand comprises:
outputting the clustered search results under the potential demand, in a designated area in a search result page.

23. The non-volatile computer storage medium according to claim 16, wherein before clustering the search result under a potential demand of the query keyword, the method further comprises:
obtaining the potential demand of the query keyword.

24. The non-volatile computer storage medium according to claim 23, wherein the obtaining the potential demand of the query keyword comprises:
obtaining the potential demand of the query keyword according to the query keyword and a correspondence relationship between the designated query keyword and potential demand.

25. The non-volatile computer storage medium according to claim 24, wherein before obtaining the potential demand of the query keyword according to the query keyword and a correspondence relationship between the designated query keyword and potential demand, the method further comprises:
obtaining user's historical behavior data related to the designated query keyword;
obtaining historical demands of the designated query keyword according to the user's historical behavior data;
according to the historical demands, obtaining the potential demand corresponding to the designated query keyword; and
establishing the correspondence relationship between the designated query keyword and the potential demand.

26. The non-volatile computer storage medium according to claim 23, wherein the obtaining the potential demand of the query keyword comprises:
according to the search result, obtaining a potential demand to which the search result belongs, as the potential demand of the query keyword.

27. The non-volatile computer storage medium according to claim 26, wherein the step of, according to the search result, obtaining a potential demand to which the search result belongs, as the potential demand of the query keyword comprises:
obtaining a search demand to which the search result belongs, according to the search result; and
obtaining the potential demand of the query keyword according to the search demand.
